(19) United States
(12) Patent Application Publication
(10) Pub. No.: US 2013/0140348 A1
(43) Pub. Date: Jun. 6, 2013

(54) APPARATUS FOR FRICTION WELDING

(71) Applicant: ROLLS-ROYCE PLC, London (GB)

(72) Inventor: Andrew Nathan HUNTER, Derby (GB)

(73) Assignee: ROLLS-ROYCE PLC, London (GB)

(21) Appl. No.: 13/668,605

(22) Filed: Nov. 5, 2012

(30) Foreign Application Priority Data
Dec. 5, 2011 (GB) 1120810.5

(51) Int. Cl. B23K 20/12

(52) U.S. Cl. 228/114.5; 228/2.3

(57) ABSTRACT

Rotary friction welding apparatus comprising a clamp having a backstop for locating a part to be welded by rotary friction welding and a lateral clamp for applying lateral loads to the part to be welded; and a forge for applying forge pressure to the part to be welded when the part is located in the clamp, the clamp securing the part to be welded through a combination of forge pressure and lateral loads. The clamp has friction elements at the interface of either the lateral clamp and/or the backstop and the part to be welded.

### TECHNICAL FIELD OF INVENTION

The present invention relates to friction welding apparatus and in particular tooling for rotary friction welding apparatus.

### BACKGROUND OF INVENTION

Rotary friction welding uses the friction generated by the relative rotation and axial force to join the parts together. It is a requirement to separately clamp each part such that unwanted relative rotation between the part and its respective clamp is minimised when torque is applied. It is an object of the present invention to seek to provide improved rotary friction welding apparatus.

### STATEMENTS OF INVENTION

According to a first aspect of the invention there is provided rotary friction welding apparatus comprising a clamp having a backstop for locating a part to be welded by rotary friction welding, a lateral clamp for applying lateral loads to the part to be welded, and a forge for applying forge pressure to the part to be welded when the part is located in the clamp, the clamp securing the part to be welded through a combination of forge pressure and lateral loads; the clamp having one or more friction elements at the interface of either the lateral clamp and/or the backstop and the part to be welded.

The friction elements may be located on the interface of the lateral clamp with the part to be welded. However, preferably, one or more friction elements are located on the backstop where advantageously the forge pressure forces the part to be welded to the friction elements. The friction elements reduce the lateral load level required to secure the part and reduces the risk of part deformation. It is also possible to locate the friction element on the part to be welded.

The, or each, friction element may be a toothed, serrated or roughened pad. Each pad may have an asperity depth greater than 0.1 mm. Preferably the asperity depth is greater than 0.5 mm.

The material of the pad may be hard and is preferably a carbide which may be machined or otherwise formed into the teeth or serrations or may be provided by particles embedded within a softer material.

The backstop may be cylindrical and the one or more friction elements located on an end face thereof. The friction elements may be arranged in a circumferential array extending about the axis of the backstop. The array may be provided by a single pad which extends about the axis of the cylinder. The array may be symmetrical or asymmetrical. The backstop may be mounted to a backstop adapter and is therefore an easily replaceable part.

The lateral clamp may be in the form of a ring with the part to be welded located within the ring. Preferably the lateral loads are directed radially inwards from the lateral clamp. The ring may be sprung against a collet.

The invention may also provide a backstop having one or more friction elements for rotary friction welding apparatus.

According to a second aspect of the invention there is provided a method of rotary friction welding a first part to a second part the method comprising the steps of locating the first part in a clamp having a backstop and a lateral clamp for applying lateral loads to the part to be welded, locating the second part in a forge, rotating the first part relative to the second part and applying a forge pressure from the forge to the parts to be welded, wherein the clamp secures the part to be welded through a combination of forge pressure and lateral loads, the clamp having one or more friction elements at the interface of either the lateral clamp and/or the backstop and the first part to be welded.

The invention will now be described, by way of example only, and with reference to the accompanying drawings in which:

### DESCRIPTION OF DRAWINGS

FIG. 1 shows a schematic side view of a rotary friction welding device for rotary friction welding a first part 2 and a second part 4.

FIG. 2 depicts a clamp for rotary friction welding

FIG. 3 is a view of the clamp of FIG. 2 along line A-A

FIG. 4 is a view of the high friction element along line B-B of FIG. 3.

### DETAILED DESCRIPTION OF INVENTION

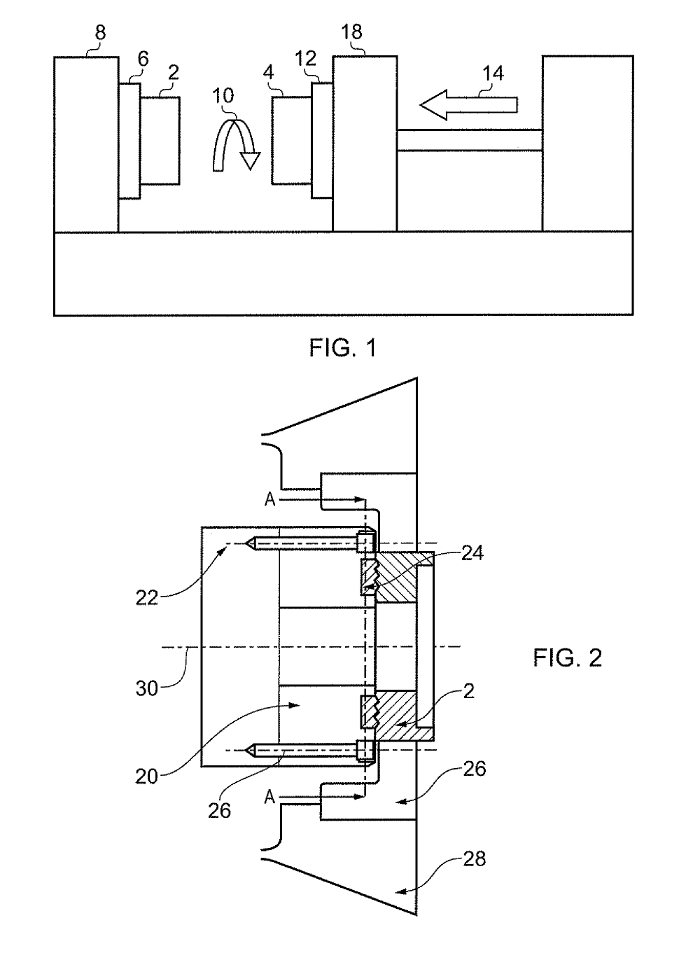

FIG. 1 shows a schematic side view of a rotary friction welding device for rotary friction welding a first part 2 and a second part 4. The first part 2 is held by a clamp 6 which is rotatably fixed to a supporting block 8. The clamp 6 and part 2 can rotate in the direction of arrow 10. The second part 4 is also mounted by a clamp 12 to supporting block 18. The second part is fixed in a non-rotational arrangement but the second part, clamp 12 and support block 18 may be translated in the direction of arrow 14 towards the first part 2.

To join the first and second parts by rotary friction welding the first part 2 is rotated in the direction of arrow 10 whilst the second part 4 is pushed onto the first part by the forge pressure or axial force denoted by arrow 14. The interface between the first and second parts is heated by friction that enables the two parts to be bonded.

A clamp 6 is shown in more detail in FIG. 2. The clamp has a backstop 20 mounted onto a backstop adaptor 22. The backstop has one or more high friction toothed carbide pads 24 against which the part 2 is seated. The part 2 is held within the clamp 6 through the use of a sprung ring 26 reacting against a collet 28.

The part 2 in rotary friction welding is usually cylindrical in nature and is either hollow or solid. The lateral loads can therefore applied by the sprung ring 26 in a radially inward direction towards the rotational axis of the part.

The combination of the lateral force applied against the component by the sprung ring and the friction between the part and the backstop prevents the part rotating relative to the clamp 6. In the absence of high friction elements high lateral loads are required, or dedicated pre-formed keyway features, to prevent the relative rotation of the part to the clamp during the friction welding. Where the lateral loads are relied upon the loads may need to be of such magnitude that the component may be significantly distorted. Where a keyway is used the part requires additional sacrificial material and machining operations which adds to the cost of the manufacturing process.

A high friction interface is employed between the backup 20 and the part 2. An array of removable toothed carbide pads is located on the front of the backup face, against which the component is seated. During rotary friction welding, the forge load causes the teeth to become embedded in the sacrificial material at the rear of the part 2. The indentation of each tooth provides an in-plane resistive shear force in the direction of rotation, thereby providing torque restraint. Prior to beginning the weld process a pre-load is applied to the parts to ensure the teeth are embedded and the part sits flush against the backup. The arrangement described for the rotating side of the system can also be applied to the non-rotating side, such as the clamp arrangement 12 of FIG. 1.

Through the introduction of the high friction elements it has been found possible to reduce the lateral loads yet still ensure that the process torque loads can be reacted without the requirement of a pre-formed keyway.

For the embodiment shown in FIG. 2 the coefficient of friction μ is calculated using the following formula:

μ_{required}=Torque_{process}/(Forge Load_{process}×Radius_{friction surface})

where: the Radius_{friction surface} is the radius of the carbide pads. The friction of the pads being sufficiently high that it dominates the rest of the backstop friction.

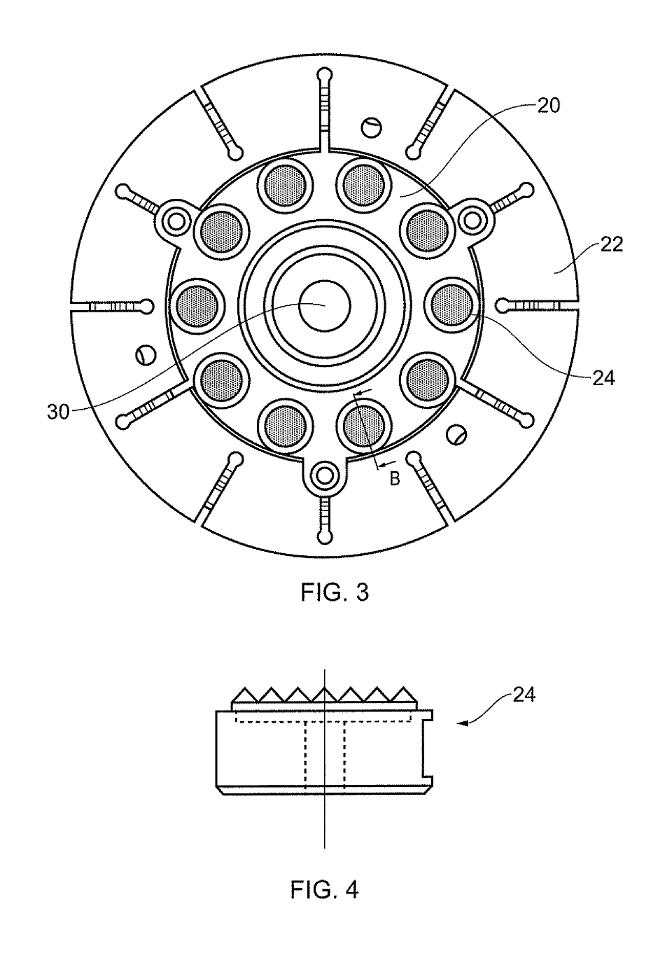

FIG. 3 is a view from the front of the spindle of FIG. 2 with the part 2 removed. The backstop 20 is mounted to the backstop adaptor 22 by screws 26. The backstop is therefore a replaceable item which permits simple replacement should the high friction elements be worn in use. Furthermore, the individual high friction elements are located in such a way (e.g. use of a grub screw) as to allow individual removal and replacement due to wear. In the preferred embodiment shown in FIG. 3 the high friction elements are toothed carbide pads arranged in a circumferential array about the rotational axis 30 of the part 2.

A preferred high friction element is a toothed pad formed of carbide having a treatment depth, or asperity height, in excess of 0.1 mm and possibly greater than 0.5 mm. It will be appreciated that the actual shape of the area of the friction element need not be circular and any appropriate 2 dimensional shape may be used. There may also be just one friction element which preferably extends symmetrically in a ring about the part axis 30. The friction element(s) may be arranged symmetrically or asymmetrically depending on the torque loads that need to be resisted and the area available to react them.

As an alternative to toothed carbide pads other toothed or serrated surfaces may be used with or without hardened properties to provide a high friction interface. Although it is not essential it is desirable for the friction elements to dig into the part 2 and therefore have a greater hardness than the part.

Rotary friction welding includes, in particular, inertia welding. However, the invention is equally applicable to other rotary friction welding processes where an axial load is available.

1. Rotary friction welding apparatus comprising
a clamp having
a backstop for locating a part to be welded by rotary friction welding and a lateral clamp for applying lateral loads to the part to be welded; and
a forge for applying forge pressure to the part to be welded when the part is located in the clamp,
the clamp securing the part to be welded through a combination of forge pressure and lateral loads;
the clamp having one or more friction elements at the interface of the backstop and the part to be welded.

2. Rotary friction welding apparatus according to claim 1, wherein the or each friction element is a toothed, serrated or roughened pad with an asperity depth greater than 0.1 mm.

3. Rotary friction welding apparatus according to claim 2, wherein the toothed, serrated or roughened pad has an asperity depth greater than 0.5 mm.

4. Rotary friction welding apparatus according to claim 2, wherein the asperity depth is less than 0.5 mm.

5. Rotary friction welding apparatus according to claim 2, wherein the backstop is cylindrical and the one or more friction elements are located on an end face thereof.

6. Rotary friction welding apparatus according to claim 1, wherein the friction element is a plurality of carbide pads.

7. Rotary friction welding apparatus according to claim 5, wherein each carbide pad is replaceable.

8. Rotary friction welding apparatus according to claim 5, wherein the carbide pads are arranged in a circumferential array extending about the axis of the backstop.

9. Rotary friction welding apparatus according to claim 5, wherein the friction element comprises a plurality of a toothed, serrated or roughened pads each with an asperity depth greater than 0.1 mm.

10. Rotary friction welding apparatus according to claim 8, wherein the asperity depth of each of the pads is less than 0.5mm.

11. Rotary friction welding apparatus according to claim 1, wherein the lateral clamp is in the form of a ring with the part to be welded located within the ring.

12. Rotary friction welding apparatus according to claim 8, wherein the lateral loads are directed radially inwards from the lateral clamp.

13. Rotary friction welding apparatus according to claim 10, wherein the ring is sprung against a collet.

14. A backstop for rotary friction welding apparatus according to claim 2.

15. A method of rotary friction welding a first part to a second part the method comprising the steps of locating the first part in a clamp having a backstop and a lateral clamp for applying lateral loads to the part to be welded,
locating the second part in a forge,
rotating the first part relative to the second part and applying a forge pressure from the forge to the parts to be welded, wherein
the clamp secures the part to be welded through a combination of forge pressure and lateral loads,
the clamp having one or more friction elements at the interface of the backstop and the first part to be welded.
